(19) United States
(12) Patent Application Publication
(10) Pub. No.: US 2008/0077936 A1
(43) Pub. Date: Mar. 27, 2008

(54) Method and apparatus for automatically launching an application from a browser

(76) Inventors: Amit Goel, New Delhi (IN); Michael J. Krack, Los Altos, CA (US); Ronald S. Rozensky, Bradenton, FL (US); Ernest Lee Shero, McKinney, TX (US)

Correspondence Address: Ryan, Mason & Lewis, LLP, Suite 205, 1300 Post Road, Fairfield, CT, 06824, US

(21) Appl. No.: 11/526,194

(22) Filed: Sep. 22, 2006

(51) Int. Cl. G06F 9/54

(52) U.S. Cl. 719/312

(57) ABSTRACT

Methods and apparatus are provided for automatically launching an application from a browser. According to one aspect of the invention, content in a browser having one or more tabbed viewing panes is processed by determining if a user indicates that contents of a selected viewing pane should be duplicated in a second application; storing an object associated with the selected viewing pane in a memory for inter-process communication of data; and sending an inter-process communication to facilitate the second application to duplicate the contents of the selected viewing pane, wherein the second application operates independently of the browser.

### FIELD OF THE INVENTION

The present invention relates generally to web browser techniques for accessing information over the Internet, and more particularly, to techniques for automatically launching an application from a browser.

### BACKGROUND OF THE INVENTION

The Internet (World Wide Web) is a valuable resource that provides vast amounts of information to users. Web browsers, such as Microsoft Internet Explorer, are applications that allow users to access information over the Internet. Most web browsers are implemented using a graphical user interface (GUI) that allows a user to take actions through a series of “point and click” operations. Graphical user interfaces typically include tabs (e.g., rectangular boxes containing a text label or an icon), that are each associated with a different viewing pane. The tabs allow a user to easily switch between different content, for example, by clicking on a desired tab with a mouse. When a given tab is selected, the content associated with the tab is presented to the user.

A number of web browsers, often referred to as tabbed browsers, include such tab functionality. For example, more recent versions of Microsoft Internet Explorer, Konqueror, Firefox, and Opera browsers provide tab browsing functionality, whereby users can view multiple web pages in a browser, each accessible by a corresponding tab. Tabbed browsers allow users to switch between different web pages associated with each tab, without having to switch top-level windows.

While tabbed browsers provide a convenient mechanism for accessing multiple web pages simultaneously and some provide functionality for launching another application to view selected content, they suffer from a number of limitations, which if overcome could further improve the utility and efficiency of such browsers. For example, existing browsers are not believed to provide satisfactory functionality to allow another application, such as another browser or a different application, to be automatically launched from the original browser.

A need therefore exists for improved methods and apparatus for automatically launching an application from a browser.

### SUMMARY OF THE INVENTION

Generally, methods and apparatus are provided for automatically launching an application from a browser. According to one aspect of the invention, content in a browser having one or more tabbed viewing panes is processed by determining if a user indicates that contents of a selected viewing pane should be duplicated in a second application; storing an object associated with the selected viewing pane in a memory for inter-process communication of data; and sending an inter-process communication to facilitate the second application to duplicate the contents of the selected viewing pane, wherein the second application operates independently of the browser.

In one exemplary implementation, the second application can be a new child browser which is created by cloning the browser. The second application can also be an existing browser and an object associated with a selected viewing pane is cloned into the memory for inter-process communication of data. The existing browser can instantiate a new tab loading contents of the memory for inter-process communication of data.

In a further implementation, the second application is a new application associated with a file type for the contents of the selected viewing pane and an instance of the new application is instantiated with a reference to the memory for inter-process communication of data. The second application can also be an existing application and a new document of a file type associated with the contents of the selected viewing pane is instantiated and the contents from the memory for inter-process communication of data into the new document are loaded into the new document.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary screen shot of an illustrative conventional tabbed browser;

FIG. 2 is a flow diagram illustrating an exemplary inter-process communication technique for automatically launching a child browser from an existing parent browser;

FIG. 3 is a flow chart describing an exemplary inter-process communication process of FIG. 2 in further detail;

FIG. 4 is a flow chart describing an alternative exemplary inter-process communication process of FIG. 2 in further detail;

FIG. 5 is a flow diagram illustrating an exemplary inter-process communication technique for automatically launching another application from an existing browser;

FIG. 6 is a flow chart describing an exemplary inter-process communication process of FIG. 5 in further detail; and

FIG. 7 is a flow chart describing an alternative exemplary inter-process communication process of FIG. 5 in further detail.

### DETAILED DESCRIPTION

The present invention provides methods and apparatus for automatically launching an application from a browser. The present invention allows a user to drag a tab from a browser to create a new browser or another application containing the content associated with the selected tab. According to a first aspect of the invention, inter-process communication (IPC) techniques are employed for automatically launching a selected tab in a child browser from an existing parent browser. For example, the selected tab can be dragged outside of an existing browser to automatically launch a new browser with the selected content, or the selected content can be dragged from a first browser to another existing browser.

According to another aspect of the invention, inter-process communication techniques are employed for automatically launching a selected tab in another application from an existing browser. For example, a user can drag an application specific tab from a browser outside the browser to launch the corresponding application, or the user can drag an application specific tab from a browser outside the browser to an existing application.

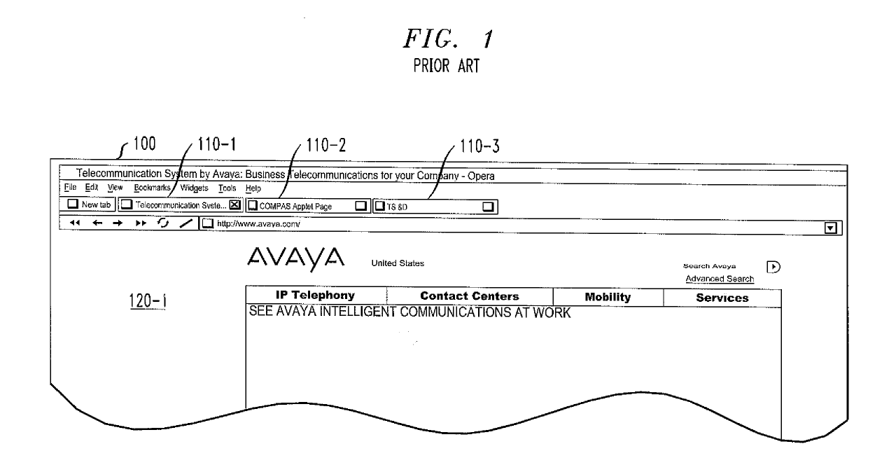

FIG. 1 illustrates an exemplary screen shot of an illustrative conventional tabbed browser 100. The tabbed browser 100 may be embodied, for example, as tabbed versions of Microsoft Internet Explorer, Konqueror, FireFox, or an Opera browser. As shown in FIG. 1, the tabbed browser 100 has a plurality of tabs 110-1 through 110-3, each with an associated web page. The tabs 110 allow a user to switch between different content, for example, by clicking on a desired tab with a mouse. When a given tab is selected, such as tab 110-1 in FIG. 1, the content associated with the tab 110-1 is presented to the user in the corresponding viewing pane 120-1.

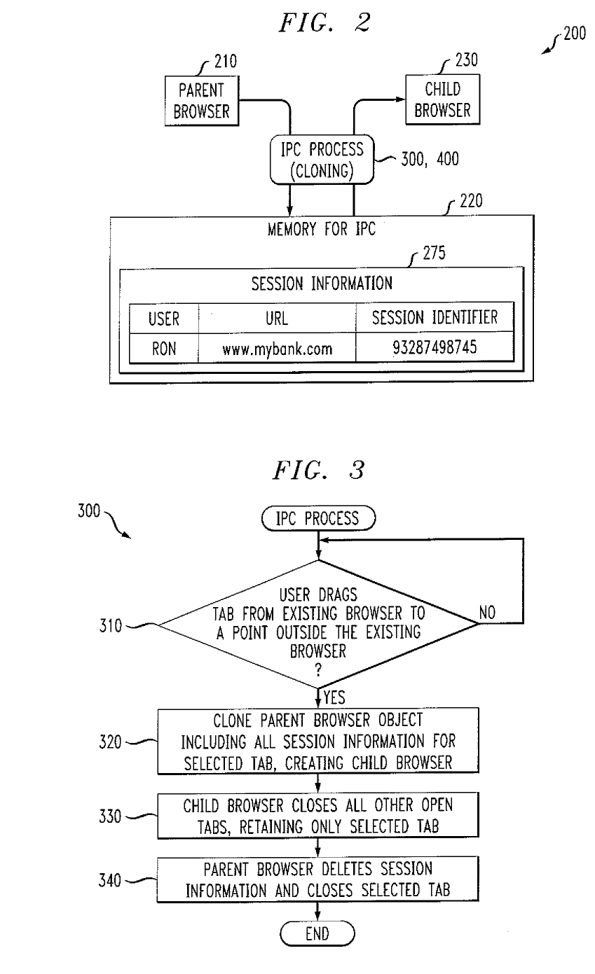

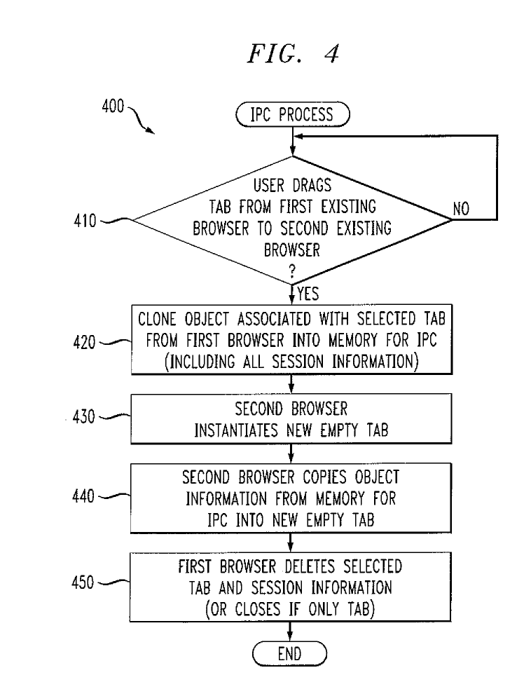

FIG. 2 is a flow diagram illustrating an exemplary inter-process communication technique 200 for automatically launching a selected tab in a new or existing child browser 230 from an existing parent browser 210. As shown in FIG. 2, an IPC process 300 or 400, as discussed further below in conjunction with FIGS. 3 and 4, respectively, clones the object associated with the parent browser 210, including all session information for the selected tab. In this manner, a selected tab can be dragged outside of an existing browser 210 to automatically launch a new browser 230 with the selected content (FIG. 3), or the selected content can be dragged from a first browser 210 to another existing browser 230 (FIG. 4).

As shown in FIG. 2, the IPC processes 300, 400 use a memory 220 for inter-process communication of data to store the cloned object and session information 275. The memory 220 for inter-process communication may be embodied, for example, as a shared memory, a temporary file on a disk, or a temporary file in memory (or some combination thereof). The exemplary session information 275 identifies the user and server associated with the session information, and includes the session identifier assigned by the server to identify the user for the session.

FIG. 3 is a flow chart describing an exemplary implementation of the inter-process communication process 300 of FIG. 2 in further detail. As shown in FIG. 3, the IPC process 300 initially monitors during step 310 to detect when the user drags a selected tab from an existing browser to a point outside the existing browser. When the IPC process 300 determines that the user has dragged a selected tab from an existing browser to a point outside the existing browser, program control proceeds to step 320 where the parent browser object is cloned, including all session information for the selected tab, creating the child browser. Thereafter, the child browser closes all other open tabs during step 330, retaining only the selected tab. Finally, the parent browser deletes the session information and closes the selected tab during step 340.

FIG. 4 is a flow chart describing an alternative implementation of the inter-process communication process 400 of FIG. 2 in further detail. As shown in FIG. 4, the IPC process 400 initially monitors during step 410 to detect when the user drags a selected tab from a first existing browser to a second existing browser. When the IPC process 400 determines that the user has dragged a selected tab from a first existing browser to a second existing browser, program control proceeds to step 420 where the object associated with the selected tab from the first browser, and any session information, is cloned into a memory 220 for IPC.

The second browser instantiates a new empty tab during step 430 and copies the object information from the memory 220 for IPC into a new empty tab during step 440. Finally, the first browser deletes the selected tab and session information (or closes if the selected tab was the only tab) during step 450.

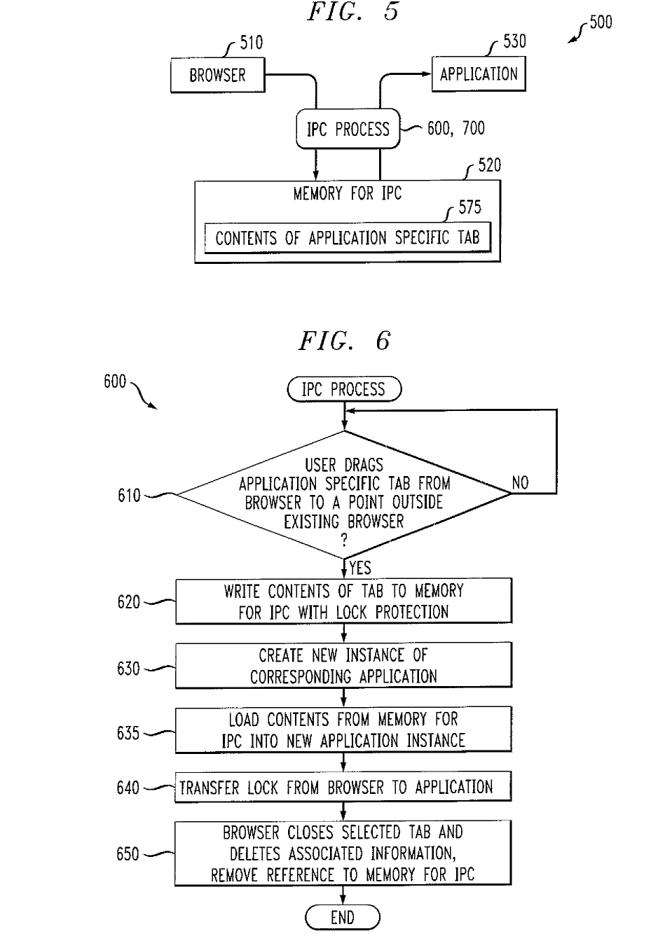

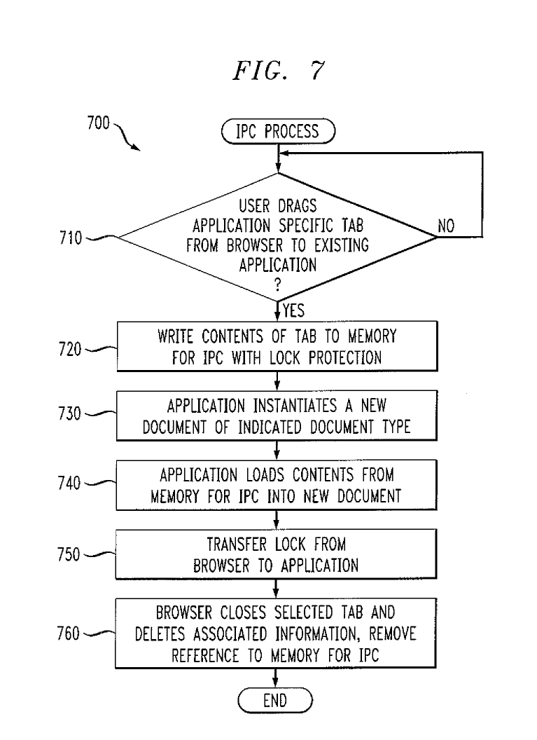

FIG. 5 is a flow diagram illustrating an exemplary inter-process communication technique 500 for automatically launching a selected tab in another application from an existing browser. As shown in FIG. 5, an IPC process 600 or 700, as discussed further below in conjunction with FIGS. 7 and 8, respectively, writes the contents 575 of the application specific tab associated with the browser 510 into a memory 520 for IPC. In this manner, a selected tab can be dragged outside of a browser 510 to automatically launch a new application 530 appropriate for the selected content (FIG. 6), or the selected content can be dragged from a browser 510 to an existing application 530 (FIG. 7). The application may be, for example, Microsoft Word, Microsoft Excel, Microsoft PowerPoint, Visio, or Adobe Acrobat.

FIG. 6 is a flow chart describing an exemplary inter-process communication process 600 of FIG. 5 in further detail. As shown in FIG. 6, the IPC process 600 initially monitors during step 610 to detect when the user drags an application specific tab from an existing browser to a point outside the existing browser. When the IPC process 600 determines that the user has dragged an application specific tab from an existing browser to a point outside the existing browser, program control proceeds to step 620 where the contents of the selected tab are written to the memory 520 for IPC, typically with lock protection.

A new instance of the application corresponding to the content of the selected tab is created during step 630. For example, the file extension of the content from the selected tab can be analyzed to determine an appropriate application for the content, in a known manner. The contents from the memory 520 for IPC are loaded into the new application instance during step 635.

The lock is then transferred from the browser to the new application during step 640. Finally, the browser closes the selected tab and deletes all associated information, removing reference to the memory 520 for IPC during step 650.

FIG. 7 is a flow chart describing an alternative exemplary inter-process communication process 700 of FIG. 5 in further detail. As shown in FIG. 7, the IPC process 700 initially monitors during step 710 to detect when the user drags an application specific tab from an existing browser to another application. When the IPC process 700 determines that the user has dragged an application specific tab from a first browser to another application, program control proceeds to step 720 where the contents of the selected tab are written to the memory 520 for IPC, typically with lock protection. The second application 530 then instantiates a new document of the indicated document type during step 730 and loads the contents from the memory 520 for IPC into the new document during step 740.

The lock from is transferred from the browser 510 to the application 530 during step 750. Finally, during step 760, the browser 510 closes the selected tab and deletes any associated information, including removing any reference to the memory 520 for IPC.

While the figures herein show an exemplary sequence of steps, it is also an embodiment of the present invention that the sequence may be varied. Various permutations of the algorithms are contemplated as alternate embodiments of the invention.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for processing content in a browser having one or more tabbed viewing panes, comprising:
determining if a user indicates that contents of a selected viewing pane should be duplicated in a second application;
storing an object associated with said selected viewing pane in a memory for inter-process communication of data; and
sending an inter-process communication to facilitate said second application to duplicate said contents of said selected viewing pane, wherein said second application operates independently of said browser.

2. The method of claim 1, wherein said memory for inter-process communication of data comprises one or more of a shared memory, a temporary file on a disk, and a temporary file in memory.

3. The method of claim 1, wherein said second application is a new child browser and wherein said method further comprises the steps of cloning said browser to create said child browser.

4. The method of claim 3, wherein said object includes session information.

5. The method of claim 3, further comprising the step of closing all tabbed viewing panes in said child browser other than said selected viewing pane.

6. The method of claim 3, further comprising the step of closing said selected viewing pane in said browser.

7. The method of claim 3, further comprising the step of said browser removing all references to session information associated with said selected viewing pane.

8. The method of claim 1, wherein said second application is an existing browser and wherein said method further comprises the step of cloning an object associated with said selected viewing pane into said memory for inter-process communication of data.

9. The method of claim 8, wherein said object includes session information.

10. The method of claim 8, further comprising the step of facilitating said existing browser to instantiate a new tab loading contents of said memory for inter-process communication of data.

11. The method of claim 8, further comprising the step of closing said selected viewing pane in said browser.

12. The method of claim 8, further comprising the step of removing all references to session information associated with said selected viewing pane in said browser.

13. The method of claim 8, further comprising the step of removing all references to said memory for inter-process communication of data in said browser.

14. The method of claim 1, wherein said second application is a new application associated with a file type for said contents of said selected viewing pane and wherein said method further comprises the step of instantiating an instance of said new application with a reference to said memory for inter-process communication of data.

15. The method of claim 14, wherein a lock is placed on said memory for inter-process communication of data, and said lock is transferred from said browser to said new application.

16. The method of claim 14, further comprising the step of closing said selected viewing pane in said browser.

17. The method of claim 14, further comprising the step of said browser removing references to said memory for inter-process communication of data.

18. The method of claim 1, wherein said second application is an existing application and wherein said method further comprises the steps of instantiating a new document of a file type associated with said contents of said selected viewing pane and loading said contents from said memory for inter-process communication of data into said new document.

19. The method of claim 18, wherein a lock is placed on said memory for inter-process communication of data and said lock is transferred from said browser to said existing application.

20. The method of claim 18, further comprising the step of closing said selected viewing pane in said browser.

21. The method of claim 1, wherein said determining step comprises the step of determining if said user drags said selected viewing pane outside of said browser.

22. The method of claim 1, wherein said determining step comprises the step of determining if said user initiates a predefined function command.

23. The method of claim 22, wherein said predefined function command is accessed from one or more of a pull down menu or a menu accessed by a mouse click.

24. A system for processing content in a browser having one or more tabbed viewing panes, comprising:
a memory including a memory for inter-process communication; and
at least one processor, coupled to the memory, operative to:
determine if a user indicates that contents of a selected viewing pane should be duplicated in a second application;
store an object associated with said selected viewing pane in said memory for inter-process communication of data; and
send an inter-process communication to facilitate said second application to duplicate said contents of said selected viewing pane, wherein said second application operates independently of said browser.

25. The system of claim 24, wherein said memory for inter-process communication of data comprises one or more of a shared memory, a temporary file on a disk, and a temporary file in memory.

26. The system of claim 24, wherein said second application is a new child browser and wherein said method further comprises the steps of cloning said browser to create said child browser.

27. The system of claim 26, wherein said processor is further configured to close all tabbed viewing panes in said child browser other than said selected viewing pane.

28. The system of claim 26, wherein said processor is further configured to remove all references in said browser to session information associated with said selected viewing pane.

29. The system of claim 24, wherein said second application is an existing browser and wherein said method further comprises the step of cloning an object associated with said selected viewing pane into said memory for inter-process communication of data.

30. The system of claim 29, wherein said processor is further configured to facilitate said existing browser to instantiate a new tab loading contents of said memory for inter-process communication of data.

31. The system of claim 29, wherein said processor is further configured to close said selected viewing pane in said browser and remove all references to session information associated with said selected viewing pane in said browser.

32. The system of claim 29, wherein said processor is further configured to remove all references to said memory for inter-process communication of data in said browser.

33. The system of claim 24, wherein said second application is a new application associated with a file type for said contents of said selected viewing pane and wherein said method further comprises the step of instantiating an instance of said new application with a reference to said memory for inter-process communication of data.

34. The system of claim 24, wherein a lock is placed on said memory for inter-process communication of data, and said lock is transferred from said browser to said new application.

35. The system of claim 24, wherein said second application is an existing application and wherein said processor is further configured to instantiate a new document of a file type associated with said contents of said selected viewing pane and load said contents from said memory for inter-process communication of data into said new document.

36. The system of claim 35, wherein a lock is placed on said memory for inter-process communication of data and said lock is transferred from said browser to said existing application.

37. The system of claim 24, wherein said processor is further configured to determine if said user drags said selected viewing pane outside of said browser or initiates a predefined function command.

38. An article of manufacture for processing content in a browser having one or more tabbed viewing panes, comprising a machine readable medium containing one or more programs which when executed implement the steps of:
determining if a user indicates that contents of a selected viewing pane should be duplicated in a second application;
storing an object associated with said selected viewing pane in a memory for inter-process communication of data; and
sending an inter-process communication to facilitate said second application to duplicate said contents of said selected viewing pane, wherein said second application operates independently of said browser.
